(19) United States
(12) Patent Application Publication
(10) Pub. No.: US 2021/0119276 A1
(43) Pub. Date: Apr. 22, 2021

(54) Battery box structure for scooter

(71) Applicant: SHENZHEN XIDESHENG BICYCLE CO.,LTD, Shenzhen (CN)

(72) Inventor: Yanke Tan, Shenzhen City (CN)

(21) Appl. No.: 16/819,150

(22) Filed: Mar. 15, 2020

(30) Foreign Application Priority Data
Oct. 20, 2019 (CN) 201921774136.2

(51) Int. Cl. H01M 10/46; H01M 10/42

(52) U.S. Cl. CPC H01M 10/46; H01M 2220/20; H01M 10/4257

(57) ABSTRACT

The present utility model discloses a battery box structure for a scooter, comprising a housing, wherein the housing is internally provided with a cell cavity and an isolation cavity, the cell cavity is used for disposing a cell therein, and the isolation cavity is internally provided with a charging base and a power supply base. In the present utility model, the cell, the charging base and the power supply base are respectively placed into two separate cavities, and the cell cavity is easier to fit with the size of a purchased cell, so that the overall structure is more stable and the waterproof effect is improved.

### TECHNICAL FIELD

The present, utility model relates to the technical field of electric scooters, and in particular to a battery box structure for an electric scooter.

### BACKGROUND ART

There are many contact, structures in a battery box structure for the existing electric scooter; and a cell, a charging base and a power supply base are in the same cavity, and the connection between them is unstable and the waterproof effect is poor.

### SUMMARY OF THE UTILITY MODEL

The technical problem to be solved by the present utility model is to, aiming at the defects in the prior art, provide a battery box structure for an electric scooter.

In order to solve the above-mentioned technical problem, the present utility model uses the technical solution as follows:

a battery box structure for a scooter, comprising a housing, wherein the housing is internally provided with a cell cavity and an isolation cavity, the cell cavity is used for disposing a cell therein, and the isolation cavity is internally provided with a charging base and a power supply base.

Preferably, the housing, comprises an upper cover and a base, the upper cover and the base are snap-fitted by a snap joint, and the upper cover and the base are internally provided with an upper transverse rib and a lower transverse rib, respectively; after snap-fit, the upper and lower transverse ribs correspondingly form the cell cavity and the isolation cavity; and the lower transverse rib is provided with an opening.

Preferably, a charging base opening is provided at the upper cover corresponding to the isolation, cavity, and the charging base, is provided at the charging base opening.

Preferably, a power supply base opening is provided on a side wall of the base corresponding to the isolation cavity, and the power supply base is provided at the power supply base opening.

Preferably, a handle is provided on a side wall of the cell cavity, and the handle comprises and is formed by snap-fitting a lower grip located on the base and an upper grip located on the upper cover.

Preferably, the base is provided with a step portion.

Preferably, an inner side wall of the cell cavity is provided with a circuit board, an outer side wall thereof is provided with a power button display marker, and the power button display marker is connected to the circuit board.

### Technical Effects

1. The cell, the charging base and the power supply base are respectively placed into two separate cavities, and the cell cavity is easier to fit with the size of a purchased cell, so that the overall structure is more stable and the waterproof effect is improved; and
2. the design of a lifting handle and the snap joint of the battery box makes the operation more humanized, meanwhile, it is easier to fix the battery box when, same is mounted in a scooter.

### BRIEF DESCRIPTION OF THE DRAWINGS

FIG. 1 is an exploded structural schematic diagram of the present utility model; and

FIG. 2 is a top perspective view of the structure of a base of the present utility model.

### DETAILED DESCRIPTION OF EMBODIMENTS

The present utility model will be described in detail below in conjunction with the accompanying drawings and embodiments.

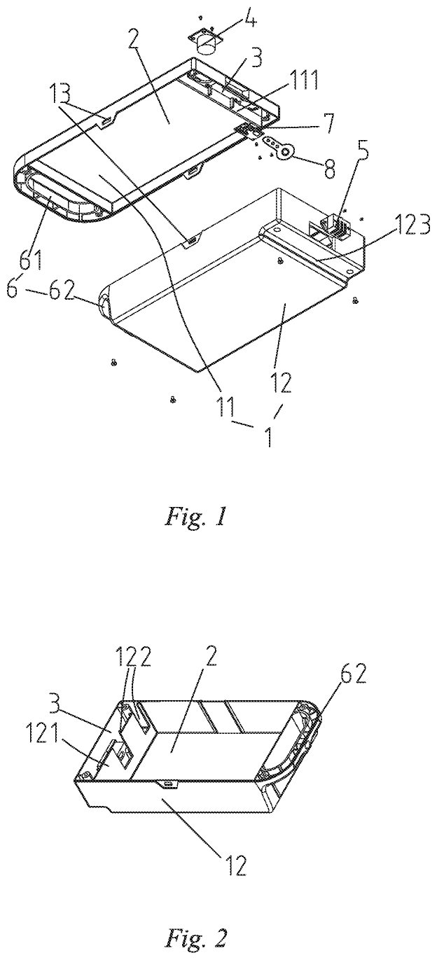

As shown in FIG. 1 and FIG. 2, the present utility model discloses a battery box structure for a scooter, comprising a housing 1, wherein the housing 1 is internally provided with a cell cavity 2 and an isolation cavity 3, the cell cavity 2 is used for disposing a cell therein, and the isolation cavity 3 is internally provided with a charging base 4 and a power supply base 5. The cell, the charging base 4 and the power supply base 5 are respectively placed into two separate cavities, the cell cavity 2 is easier to fit with the size of a purchased cell, which is more suitable for standardized production, and the overall structure is more stable and the waterproof effect is improved.

Specifically, the housing 1 comprises an upper, cover 11 and a base 12, the upper cover 11 and the base 12 are snap-fitted by a snap joint 13, and the upper cover 11 and the base 12 are internally provided with an upper transverse rib 111 and a lower transverse rib 121, respectively; after snap-fit, the upper and lower transverse ribs 111, 121 correspondingly form the cell cavity 2 and the isolation cavity 3; and the lower transverse rib 121 is provided with an opening 122 to facilitate a contact connection between the cell, the charging base 4 and the power supply base 5.

Specifically, a charging base opening is provided at the upper cover 11 corresponding to the isolation cavity 3, and the charging base 4 is provided at the charging base opening.

Specifically, a power supply base opening is provided on a side wall of the base 12 corresponding to the isolation cavity 3, and the power supply base 5 is provided at the power supply base opening.

Specifically, a handle 6 is provided on a side wall of the cell cavity 2, and the handle 6 comprises and is formed by, snap-fitting a lower grip 62 located on the base 2 and an upper grip 61 located on the upper cover 11. The upper grip 61 and the lower grip 62 form the handle 6, which facilitates the extraction and installation of the battery box, and also makes the snap-fit between the upper cover 11 and the base 12 more stable.

Specifically, the base 12 is provided with a step portion 123, which facilitates installation onto the scooter.

Specifically, an inner side wall of the cell cavity 2 is provided with a circuit board 7, an outer side wall thereof is provided with a power button display marker 8, and the power button display marker 8 is connected to the circuit board 7. If the power button display marker 8 is pressed, different display lamps light on to indicate the power stored in the cell.

The above embodiments are merely preferred embodiments of the present utility model but not intended to limit the present utility model, and any modifications, equivalent replacements, improvements, etc. made within the technical scope of the present utility model should be included within the scope of protection of the present utility model.

1. A battery box structure for a scooter, comprising a housing, characterized in that the housing is internally provided with a cell cavity and an isolation cavity, the cell cavity is used for disposing a cell therein, and the isolation cavity is internally provided with a charging base and a power supply base.

2. The battery box structure for a scooter according to claim 1, characterized in that the housing comprises an upper cover and a base, the upper cover and the base are snap-fitted by a snap joint, and the upper cover and the base are internally provided with an upper transverse rib and a lower transverse rib, respectively; after snap-fit, the upper and lower transverse ribs correspondingly form the cell cavity and the isolation cavity; and the lower transverse rib is provided with an opening.

3. The battery box structure for a scooter according to claim 2, characterized in that a charging base opening is provided at the upper cover corresponding to the isolation cavity, and the charging base is provided at the charging base opening.

4. The battery box structure for a scooter according to claim 2, characterized in that a power supply base opening is provided on a side wall of the base corresponding to the isolation cavity, and the power supply base is provided at the power supply base opening.

5. The battery box structure for a scooter according to claim 2, characterized in that a handle is provided on a side wall of the cell cavity, and the handle comprises and is formed by snap-fitting a lower grip located on the base and an upper grip located on the upper cover.

6. The battery box structure for a scooter according to claim 2, characterized in that the base is provided with a step portion.

7. The battery box structure for a scooter according to claim 1, characterized in that an inner side wall of the cell cavity is provided with a circuit board, an outer side wall thereof is provided with a power button display marker, and the power button display marker is connected to the circuit board.
